(19) United States
(12) Patent Application Publication
(10) Pub. No.: US 2006/0177727 A1
(43) Pub. Date: Aug. 10, 2006

(54) Gas diffuser substrate containing catalysts for fuel cells, in addition to a method for the production thereof

(76) Inventors: Karsten Ruth, Alzenau (DE); Karl-Anton Starz, Rodenbach (DE); Marco Lopez, Frankfurt (DE)

Correspondence Address: KALOW & SPRINGUT LLP, 488 MADISON AVENUE, 19TH FLOOR, NEW YORK, NY, 10022, US

(21) Appl. No.: 10/541,173

(22) PCT Filed: Dec. 23, 2003
(86) PCT No.: PCT/EP03/14839

§ 371 Date: Feb. 6, 2006

(30) Foreign Application Priority Data
Dec. 30, 2002 (EP) 02029084.7

(51) Int. Cl. H01M 4/94; H01M 4/96; H01M 4/88

(52) U.S. Cl. 429/44; 502/101

(57) ABSTRACT

The invention relates to a catalyst-containing gas diffusion layer for fuel cells, in particular low-temperature fuel cells, e.g. PEMFCs and DMFCs. The gas diffusion layer is used on the anode side of the fuel cell and contains catalyst components which effect removal of carbon monoxide (in the PEMFC) or oxidation of methanol (in the DMFC). The catalyst components are produced directly in the porous substrate material from suitable precursor compounds by heat treatment and are distributed uniformly over the entire volume of the gas diffusion layer. As a result, the catalyst components have a particularly high activity. Furthermore, a process for producing a catalyst-containing gas diffusion layer is described. The gas diffusion layers are used in membrane-electrode units (MEUs) for low-temperature fuel cells, in particular for PEM fuel cells operated using a CO-containing reformate gas. They can also be used in direct methanol fuel cells (DMFCs).

The invention relates to a catalyst-containing gas diffusion layer for fuel cells, in particular low-temperature fuel cells (such as PEMFCs or DMFCs) having an ion-conducting polymer as electrolyte. The gas diffusion layer is used on the anode side of the fuel cell and comprises catalyst components which can, for example, remove carbon monoxide (CO) or oxidize methanol. Furthermore, a process for producing the catalyst-containing gas diffusion layer is described. The product is used in membrane-electrode units (MEUs) for low-temperature fuel cells, for example PEM fuel cells, which are operated using a CO-containing reformate gas. However, they can also be used for direct methanol fuel cells (DMFC).

Fuel cells convert a fuel and an oxidant at physically separate locations at two electrodes into electric current, heat and water. Hydrogen, methanol or a hydrogen-rich gas can be employed as fuel, and oxygen or air can serve as oxidant. The energy conversion process in the fuel cell is substantially pollution-free and has a particularly high efficiency. For this reason, fuel cells are becoming increasingly important for alternative drive concepts, for domestic energy supply plants and for portable applications.

Membrane fuel cells, for example the polymer electrolyte fuel cell (PEMFC) and the direct methanol fuel cell (DMFC), are suitable for many mobile and stationary applications because of their low operating temperatures, their compact construction and their power density. The technology of fuel cells is comprehensively described in the literature, for example in K. Kordesch and G. Simader, “Fuel Cells and its Applications”, VCH Verlag Chemie, Weinheim (Germany) 1996.

PEM fuel cells are made up of a stack of many fuel cell units. To increase the operating voltage, these are electrically connected in series. A fuel cell unit comprises in each case a 5-layer membrane-electrode unit (MEU) which is located between bipolar plates, also referred to as separator plates, for the supply of gas and the conduction of electrical current. Such a 5-layer membrane-electrode unit is in turn made up of a polymer electrolyte membrane provided on both sides with an electrode layer (3-layer catalyst-coated membrane, CCM). One of the electrode layers is configured as anode for the oxidation of hydrogen and the second electrode layer is configured as cathode for the reduction of oxygen. The polymer electrolyte membrane comprises proton-conducting polymers. These materials will hereinafter also be referred to as ionomers for short. Anode and cathode of the CCM comprise electrocatalysts which catalytically promote the respective reaction (oxidation of hydrogen or reduction of oxygen). As catalytically active components, preference is given to using the metals of the platinum group of the Periodic Table of the Elements. In the majority of cases, supported catalysts are used.

Gas diffusion layers (GDLs or “backings”) are then applied to the two sides of the CCM, so that the 5-layer membrane-electrode unit is then obtained. The gas diffusion layers usually comprise carbon fibre paper or woven carbon fibre fabric and make it possible for the reaction gases to gain ready access to the reaction layers and for the cell current and the water formed to be conducted away effectively.

To achieve wide commercial use of PEM fuel cells in motor vehicles and domestic energy supply plants, a further improvement in the electrochemical cell power and life, in particular when using CO-containing reformate gases, is necessary.

Typical hydrogen-containing fuel gases produced by reforming of hydrocarbons such as natural gas, methane, naphtha, petroleum spirit or alcohols contain, depending on purification processes, up to 2-3% by volume of carbon monoxide (CO). The carbon monoxide in turn poisons the Pt or PtRu anode catalyst and thus leads to a drop in performance of the entire PEM fuel cell.

There have been many attempts in the past to eliminate the poisoning of the anode catalyst by CO or to reduce its effect. A great deal of work has been carried out on the development of CO-tolerant electrocatalysts, primarily catalysts based on platinum/ruthenium alloys which have improved tolerance when operated in conjunction with CO-containing fuel gases (cf., for example, U.S. Pat. Nos. 6,007,934 and 6,066,410). Furthermore, the “air-bleed” process is known from the literature. Here, about 1-3% by volume of air is additionally introduced into the anode space of the cell to oxidize the CO adsorbed on the Pt or PtRu electrocatalyst to CO₂ and thus remove it (cf., for example, S. Gottesfeld and J. Pafford, J. Electrochem. Soc. 135, (1988), 139-146). The reaction proceeds in the gas phase and can be represented as follows:
CO+½O₂(air)===>CO₂ (1)

A further possible way of removing carbon monoxide from hydrogen-containing fuel gases is the methanization reaction. The CO present is reacted with hydrogen over a catalyst to form inert methane and is thus removed from the mixture:
CO+3H₂===>CH₄+H₂O (2)

Unlike the selective oxidation in accordance with eq. (1), the methanization of carbon monoxide is inherently associated with the consumption of hydrogen, but does not require an “air bleed” and thus no external introduction of air. This means a lower instrumentation requirement. While the method of CO removal by methanization is still described relatively sparsely in the literature, there are numerous proposals in the patent literature for incorporating or integrating a gas-phase-active catalyst for CO oxidation into a gas difflusion layer.

Thus, for example EP 0 736 921 B1 describes an electrode containing two different catalytic components. The first catalytic component is active for gas-phase reaction sites while the second catalytic component is active at electrochemical reaction sites. The two catalytic components are applied as a double layer (“bilayer”) to the gas diff-usion layer and are in physical contact with one another.

WO 00/36679 describes a gas diffusion layer (“backing”) for a PEM anode which has a gas-phase-active catalyst for the oxidation of CO only on the side facing away from the ionomer membrane. Gas-phase-active catalyst and electrocatalyst are both configured as thin layers and as such are not in direct contact with one another.

EP 0 985 241 describes an integral PEM fuel cell stack which has an anode configured as a three-layer anode. This has a catalyst layer which is selective for CO oxidation on the side facing away from the membrane and an electrochemically active layer on the side facing the membrane.

JP 9-129243 proposes a low-temperature (PEM) fuel cell which likewise has a gas diffusion layer containing a CO oxidation catalyst. Here, the CO oxidation catalyst is processed in a mixture of conductive material (e.g. carbon black) and water-repellent material (e.g. PTFE) to produce a porous film and is applied to the gas diffusion layer.

All the proposed solutions have the disadvantage that the gas-phase-active catalyst is present only in a thin layer on the gas diffusion layer. Owing to these thin layers, the residence time of the CO-containing fuel gas on the catalyst material is reduced. This leads to an only partial conversion and thus to incomplete CO oxidation. Furthermore, the gas-phase-active catalysts are used in the form of prefabricated supported catalysts (for example Ru on carbon black, Pt on aluminium oxide) and are then processed further in a mixture with carbon black, Teflon and, if appropriate, further constituents. In many cases, active catalyst surface is blocked by these additional constituents. The utilization of the active catalyst surface area is thus not optimal, which in turn leads to final residues of CO (e.g. amounts below 100 ppm) not being removed. This means that poisoning of the electrocatalysts on the anode of the fuel cell stack by CO continues to take place.

The above-described proposed solutions also lead to considerable complication of the fuel cell, in particular the gas diffusion system and electrode system. Additional layers have to be applied to the gas difflusion layers, which in the final analysis result in an increase in the production costs for the products because they lead to a more complex manufacturing process.

It is therefore an object of the present invention to provide an improved catalyst-containing gas diffusion layer for low-temperature fuel cells and to find a suitable process for producing such a product.

The invention accordingly provides a catalyst-containing gas difflusion layer for low-temperature fuel cells which comprises a porous support material and catalyst particles which are distributed uniformly over the entire volume of the gas diffusion layer. Advantageous embodiments of this substrate and suitable processes for producing it are described in the subsequent claims.

The catalyst-containing gas diffusion layer of the invention advantageously achieves good utilization of the catalyst or the catalyst surface area and thus a high activity and selectivity in the removal of carbon monoxide (either by CO oxidation or by methanization) and in the oxidation of methanol (in the DMFC). Furthermore, the process of the invention for producing such gas diffusion layers has a low degree of complexity. It is practical and can easily be integrated into a continuous manufacturing process, as a result of which production costs are decreased.

The catalyst-containing gas diffusion layer of the invention contains a catalytically active component which is uniformly distributed over the entire volume of the gas diffusion layer. It can be produced in a process in which precursors such as water-soluble and/or readily decomposable metal compounds which have previously been introduced into the gas diffusion layer concerned are decomposed or pyrolysed. Preference is given to using noble metal compounds for this purpose. In a preferred embodiment, a gas diffusion layer is impregnated with an aqueous solution of a precursor (e.g. a readily decomposable metal compound). This impregnation process can be carried out by means of simple dipping, by spraying, brushing or by steeping. In the simplest case, the gas diffusion layer is laid in a tank containing a solution of the metal compound, subsequently taken out and dried. The process is repeated until the required loading of the substrate with the catalytically active metal compound has been achieved. Loadings in the concentration by unit area range from 0.05 to 5 mg of metal/cm² are typically achieved by means of one to ten repetitions. However, higher concentrations per unit area, up to about 100 mg/cm², can also be achieved. In addition, it is also possible to spray the precursor solution onto both sides of the gas diffusion layer and subsequently to dry it. If the screen printing method is used, impregnation of the gas diffusion layer can be carried out by screen printing of a thin ink whose viscosity is set so that it wets the entire substrate and penetrates into it. In the gas diffusion layer of the invention, the catalyst component is uniformly distributed over the entire volume of the substrate and the catalytically active particles are preferably immobilized on the support material. An optimal dispersion of the particles in the substrate and very good access of the reactants to the catalytically active sites of the particles are ensured in this way.

The impregnation process can be carried out continuously, for example from roll-to-roll, in suitable apparatuses. Here, the gas diffusion layer can be used as a continuous, flexible strip and be conveyed through various stations, for example hydrophobisation, impregnation with precursor solution, drying, coating with an evening layer and heat treatment. The impregnation with the precursor compound can thus easily be incorporated into a continuous production process for gas diffusion layers. It thus incurs little additional expenditure but leads to a higher-value product.

The heat treatment which can be used for decomposing the precursors and in which the catalyst particles are formed is generally carried out at temperatures of from 200 to 900° C., preferably from 200 to 600° C. It can be carried out in an air atmosphere or else under protective gas (for example nitrogen, argon or mixtures thereof) or reducing gases (for example nitrogen/hydrogen mixtures or forming gas). Tunnel kilns, muffle furnaces, box furnaces and combinations thereof can be used for this purpose.

Preferred catalysts for the CO oxidation according to eq. (1) are alloys of Ru, PtRu or Pt with base metals. Furthermore, gold-containing catalysts such as Au, Au/titanium oxide or Au/iron oxide can be used. It is also possible to use supported silver-containing catalysts (for example Ag/titanium oxide).

Catalysts suitable for the methanization of CO according to eq. (2) are, for example, catalysts based on nickel and/or ruthenium. The operating temperatures of the cell when gas diffusion layers containing a methanization catalyst are used should preferably be somewhat above the normal temperatures of the PEM fuel cell. This is because at operating temperatures above 90° C., an increase in the methanization activity of the catalyst is achieved and at the same time the poisoning of the Pt-containing anode catalyst by CO is suppressed.

Precursors used for the catalytically active components are water-soluble, readily decomposable metal compounds, preferably compounds from the group consisting of amine nitrates, nitrates, carbonates, carboxylates, hydroxycarboxylates, acetates, lactates, butanoates, oxalates, formates, octanoates or ethylhexanoates, which form the desired catalyst particles on decomposition. Preferred catalyst particles encompass metals, in particular noble metals such as Pt, Pd, Ru, Rh, Au, Ag, Ir, Os and/or oxides thereof, and/or mixtures or alloys thereof with base metals, and also base metals such as Ti, Fe, Co, Mn, Cr or Ni. For corrosion reasons, halogen- or chlorine-containing precursors are avoided if possible. However, it is also possible to use, for example, organometallic complexes of the metals, known as resinates.

Examples of suitable noble metal compounds are the Pt precursors platinum(II) nitrate, platinum(II) lactate, ammineplatinum(II) nitrate, ethylammonium hexahydroxyplatinate, platinum acetate, etc. Examples of suitable Ru precursors are ruthenium(III) nitrosyl nitrate and ruthenium(III) acetate. Examples of Au-containing precursors are gold resinates such as Au polymer esters (FERRO GmbH, Frankfurt) or gold-containing complex salts. Analogous complexes of the other noble metals can of course also be used.

Precursors of base metals which can be used alone or in combination with the noble metal precursors are, for example, cobalt(II) nitrate, manganese(II) oxalate, chromium(III) nitrate, nickel(II) nitrate, iron(II) carbonate and comparable compounds of elements other than the base metals listed above. Here too, halogen-containing precursors are to be avoided for corrosion reasons.

Furthermore, additional components which function as cocatalysts, as support materials or as precursors thereof can be added to the noble metal and base metal precursors described. Examples are high-surface-area noble metal blacks, fine metal powders, carbon blacks, pyrogenic oxides such as silica (Aerosil™ from Degussa), pyrogenic titanium oxides and comparable materials. It is also possible to use other inorganic components which are converted into oxidic materials on pyrolysis or thermal treatment. Examples are organic silicon esters, organosilanes, organotitanates, organostannates, aluminates, borates and similar compounds.

The precursor compounds can be processed to give a preparation which is suitable for the respective method of application to the gas diffusion layer. In the case of application by dipping or impregnation, an appropriately low-viscosity solution is prepared. This can contain auxiliaries such as surfactants, wetting agents, binders, thickeners, antisedimentation agents or organic solvents to improve the processing properties. In the case of application by brushing or by screen printing, the viscosity of the solutions is modified appropriately; ways and means of achieving this are known to those skilled in the art.

As starting materials for producing the catalyst-containing gas diffusion layer of the invention, it is possible to use commercial carbon fibre substrates. Use is frequently made of porous carbon fibre substrates (carbon fibre papers or woven carbon fibre fabrics) having a thickness of from 100 to 400 μm. These materials usually have a porosity of from 60 to 90% and mean pore diameters of from 20 to 50 μm. There are various substrate materials which differ in their structure, production methods and properties. Examples of such porous materials are Toray paper, carbon fibre nonwovens from SGL (of the Sigracet type) or woven carbon fibre structures from Textron (of the AvCarb type). Many of these materials are obtainable in sheet or roll form. Furthermore, woven metal meshes, fine metal gauzes, woven synthetic fibre fabrics coated with conductive material, woven textiles coated with conductive material, coated glass fibres and similar materials can also be used as starting material. Basically, the gas diffusion layers may be firstly hydrophobized, hydrophilized, pressed, rolled or treated in another way before they are treated with the precursor solution.

The catalyst-containing gas diffusion layer can be provided with an compensating layer or can be without such a layer. For the purposes of the present invention, the compensating layer (“microlayer”) is a layer on that side of the gas diffusion layer which is in contact with the electrode layer in the fuel cell. The microlayer generally comprises a mixture of a hydrophobic polymer such as PTFE with finely divided carbon blacks. The microlayer is usually applied by screen printing, and its thickness is, for example, from 5 to 100 μm.

A complete membrane-electrode unit (MEU) of a PEM fuel cell or DMFC contains a catalyst-coated polymer electrolyte membrane (“CCM”) with gas diffusion layers applied to both sides. The gas diffusion layer of the invention is preferably used on the anode side of the membrane-electrode unit. Membrane-electrode units produced using the gas diffusion layer of the invention can, owing to the improved tolerance towards carbon monoxide, be employed when CO-containing hydrogen mixtures are used as fuel gas. Such fuel gases are frequently produced by reforming of hydrocarbons such as natural gas, methane or petroleum spirit and are used in stationary applications of the fuel cells.

However, the catalyst-containing gas diffusion layer of the invention can also be used in MEUs for direct methanol fuel cells (DMFCs). Here, it effects, for example, improved oxidation of the methanol on the anode side and contributes to an improvement in the power of the DMFC.

The following figures illustrate embodiments of the invention.

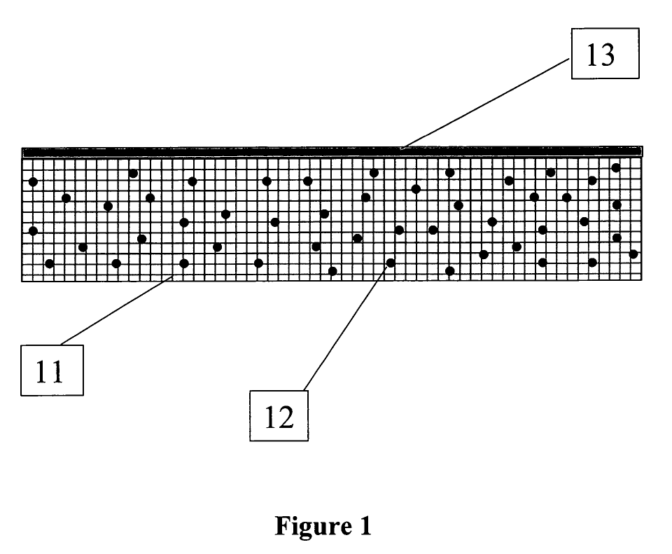

FIG. 1: Schematic depiction of the catalyst-containing gas diffusion layer of the invention with microlayer

FIG. 1 shows a schematic cross section through a catalyst-containing gas diffusion layer of the invention. Here, (11) denotes the porous substrate material. The catalyst particles (12) are immobilized on the surface of the substrate and distributed uniformly over the entire volume of the substrate. They thus have optimal accessibility, for example for a fuel gas contaminated with CO. An optional microlayer (13), which comprises, for example, PTFE and carbon black, is applied to improve contact with the electrode layer on the ionomer membrane.

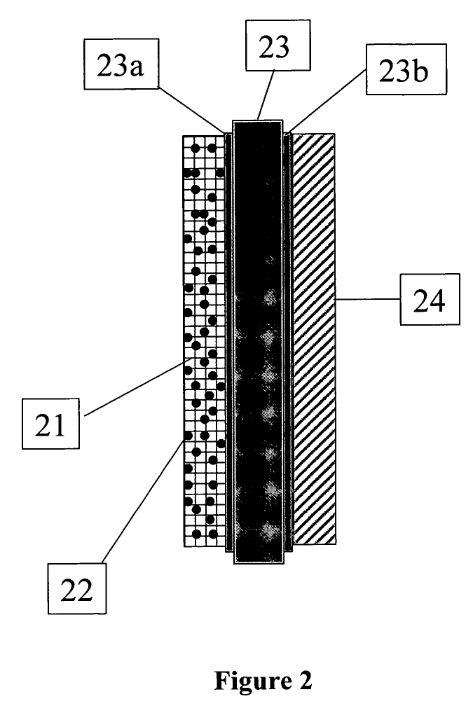

FIG. 2: Complete 5-layer membrane-electrode unit with catalyst-containing gas diffusion layer according to the invention on the anode side

FIG. 2 shows a schematic cross section through a complete 5-layer MEU provided with a gas diffusion layer (21) according to the invention containing catalyst particles (22) on the anode side. The gas diffusion layer (21) is in contact with a three-layer catalyst-coated ionomer membrane comprising an anode catalyst layer (23a), ionomer membrane (23) and cathode catalyst layer (23b). An uncatalysed gas diffusion layer (24) is applied to the cathode side. In this embodiment, the two gas diffusion layers do not have a microlayer.

The following examples illustrate the invention. However, the invention is not restricted to the embodiments described therein.

### EXAMPLES

### Example 1

The production of an Ru-containing gas diffusion layer with microlayer is described. The starting material employed is a hydrophobized carbon fibre paper having an area of 50 cm² (dimensions about 7×7 cm) and a thickness of 200 μm (Sigracet 10, from SGL Carbon). The Teflon content is about 8% by weight. After the weight has been determined by means of a laboratory balance, the carbon fibre paper is dipped into a large dish containing ruthenium(III) acetate solution (5% by weight of Ru in water, from OMG, Hanau). After complete wetting, the carbon fibre paper is taken from the immersion bath by means of tweezers. The liquid is allowed to drip off from the carbon fibre paper for a short time and the paper is subsequently dried at 100° C. for 15 minutes in a drying oven. It is then allowed to cool and the amount of Ru acetate taken up is determined gravimetrically. The dipping procedure is repeated three times until a loading of 0.85 mg of Ru acetate/cm² has been obtained. The gas diffusion layer is subsequently heated in an oven at 200° C. under forming gas (95% by volume of nitrogen, 5% by volume of hydrogen) for 30 minutes. After the gas diffusion layer has cooled, the Ru content of the gas diffusion layer is 0.48 mg of Ru/cm². The Ru particles are distributed uniformly through the layer and immobilized on the layer surface. They have a mean particle size of 5 nm, measured by means of transmission electron microscopy (TEM).

A microlayer of carbon black/PFTE is then applied by screen printing, dried and heat treated at 390° C. for 10 minutes. The thickness of the microlayer is about 20 μm.

The gas diffusion layer is combined as preanode with a catalyst-coated membrane (CCM) and assembled to produce a membrane-electrode unit (MEU). As CCM, use is made of a catalyst-coated membrane type 6 C (anode loading: 0.2 mg of Pt/cm²; cathode loading: 0.4 mg of Pt/cm², membrane EW 1100 having a thickness of 50 microns, from OMG, Hanau). A hydrophobicized carbon fibre paper having a microlayer (standard, from SGL, type Sigracet 10) is used on the cathode side.

The MEU is tested in a PEM fuel cell both in operation using hydrogen/air and using reformate/air and gives very good results, especially in operation using reformate/air at a content of 100 ppm of CO (cf. Table 1). Compared to the catalyst-free gas diffusion layer (Comparative Example CE1), the tolerance towards CO is significantly improved. This shows that the catalyst-containing gas diffusion layer of the invention has very good effectiveness.

### Example 2

The production of an Ru-containing gas diffusion layer without microlayer is described. The starting material employed is once again a hydrophobized carbon fibre paper having an area of 50 cm² (dimensions about 7×7 cm) and a thickness of 200 μm (Sigracet 10, from SGL Carbon). The Teflon content is about 8% by weight. The impregnation with precursor solution is carried out as described in Example 1. The dipping procedure is repeated twice until a loading of 0.5 mg of Ru acetate/cm² is obtained. The gas diffusion layer is subsequently heated in an oven at 250° C. under forming gas (95% by volume of nitrogen, 5% by volume of hydrogen) for 30 minutes. After the gas diffusion layer has cooled, its Ru content is 0.28 mg of Ru/cm². The Ru particles are distributed uniformly through the layer and immobilized on the surface of the layer. They have a mean particle size of 4 nm (measured by TEM). The gas diffusion layer is combined as preanode with a catalyst-coated membrane (CCM) and, as described in Example 1, assembled to produce a membrane-electrode unit (MEU). When the MEU is operated using CO-containing reformate (100 ppm of CO), very good results are obtained and a significantly improved CO tolerance compared to Comparative Example CEI (see below) is obtained.

### Example 3

The production of an Au/TiO₂-containing gas diffusion layer without microlayer is described. The starting material employed is once again a hydrophobized carbon fibre paper having an area of 50 cm (dimensions about 7×7 cm) and a thickness of 200 μm (Sigracet 10, from SGL Carbon). The Teflon content is about 8% by weight. An aqueous precursor solution containing Au polymer ester HF 3401 (FERRO, Frankfurt) and titanium oxide (grade P25, Degussa, Frankfurt) is prepared. The Au content of the solution is 5% by weight of Au, and the titanium oxide content is 0.1% by weight. The impregnation with precursor solution is carried out as described in Example 1. The dipping procedure is repeated three times. The gas diffusion layer is subsequently heated in an oven at 250° C. under forming gas for 30 minutes. After the gas diffusion layer has cooled, its Au content is about 0.1 mg of Au/cm². The Au particles are uniformly distributed together with the titanium oxide through the gas diffusion layer. The gas diffusion layer is combined as preanode with a catalyst-coated membrane (CCM) and, as described in Example 1, assembled to produce a membrane-electrode unit (MEU).

When the MEU is operated using CO-containing reformate (100 ppm of CO), very good results are obtained and a significantly improved CO tolerance compared to Comparative Example CEI (see below) is obtained.

### Comparative Example (CE1)

In this example which is not according to the invention, the production and testing of an MEU having a catalyst-free gas diffusion layer without microlayer on the anode side is described. The starting material employed is once again a hydrophobized carbon fibre paper having an are of 50 cm² (dimensions about 7×7 cm) and a thickness of 200 μm (Sigracet 10, from SGL Carbon). The Teflon content is about 8% by weight. The catalyst-free gas diffusion layer is combined with a catalyst-coated membrane (CCM) and, as described in Examples 1 and 2, assembled to produce a membrane-electrode unit (MEU). When the MEU is operated using CO-containing reformate (100 ppm of CO), very poor results are obtained due to the poisoning of the Pt catalyst by CO. This shows that the catalyst-containing gas diffusion layers according to the invention (with or without microlayer) have a very good effectiveness.

### Example 4

The production of a PtRu-containing gas diffusion layer without microlayer and its use as preanode in a direct methanol fuel cell (DMFC) are described.

The starting material employed is once again a hydrophobized carbon fibre paper having an area of 50 cm² (dimensions about 7×7 cm) and a thickness of 200 μm (Sigracet 10, from SGL Carbon). The Teflon content is about 8% by weight. After the weight has been determined by means of a laboratory balance, the carbon fibre paper is dipped into a large dish containing 6 parts of ruthenium(III) acetate solution (5% by weight of Ru in water, from OMG, Hanau) and I part of platinum(II) nitrate (16% by weight of Pt, from OMG, Hanau). After complete wetting, the carbon fibre paper is taken from the immersion bath by means of tweezers. The liquid is allowed to drip off from the carbon fibre paper for a short time and the paper is subsequently dried at 100° C. for 15 minutes in a drying oven. It is then allowed to cool and the amount of Ru acetate and Pt nitrate taken up is determined gravimetrically. The gas diffusion layer is subsequently heated in an oven at 250° C. under forming gas (95% by volume of nitrogen, 5% by volume of hydrogen) for 30 minutes. After the gas diffusion layer has cooled, the Ru content of the gas diffusion layer is about 0.65 mg of Ru/cm² and the platinum content is about 0.35 mg of Pt/cm². The Pt and Ru particles are distributed uniformly over the entire volume of the gas diffusion layer. The gas diffusion layer is combined as preanode with a catalyst-coated membrane (CCM, type R221, anode loading: 0.3 mg of Pt/cm² and 0.15 mg of Ru/cm², cathode loading: 0.4 mg of Pt/cm²; from OMG, Hanau) and, as described in Example 1, assembled to produce a membrane-electrode unit (MEU). This is installed in a direct methanol fuel cell (DMFC) having an active cell area of 50 cm². A 2 molar methanol/water solution is used for the measurement, and the cell temperature is 60° C. Air at atmospheric pressure is supplied on the cathode side. A very high peak power density of over 80 mW/cm² is obtained.

Electrochemical Tests

The PEMFC power tests are carried out using a fuel gas mixture of 60% by volume of H₂, 15% by volume of N₂ and 25% by volume of CO₂ as anode gas. 100 ppm of CO and an air bleed of 1% by volume or 3% by volume of air are added to the fuel gas. This fuel gas mixture simulates a reformate gas as can be obtained by reforming of methane or hydrocarbons by means of steam reforming and subsequent purification stages. Air is used as cathode gas. The cell temperature is 75° C. The pressure of the operating gases is 3 bar (absolute). The stoichiometry of the gases is 1.5 (anode gas) and 2.0 (cathode gas). The MEUs are measured in a cell having an active area of 50 cm² under OMG standard conditions. The results for Examples 1, 2 and 3 and for Comparative Example CE 1 are summarized in Table 1.

TABLE 1
Electrochemical tests in the PEM fuel cell (cell
voltage at a current density of 500 mA/cm²)

| | Example | Example | Example | |
|---|---|---|---|---|
| Fuel gas composition | 1 | 2 | 3 | CE1 |
| 100% by volume of H₂ | 758 mV | 751 mV | 750 mV | 750 mV |
| 60% by volume of H₂, | 726 mV | 724 mV | 725 mV | 722 mV |
| 25% by volume of | | | | |
| CO₂, 15% by volume | | | | |
| of N₂ | | | | |
| 60% by volume of H₂, | 664 mV | 592 mV | 550 mV | not |
| 25% by | | | | measur- |
| volume of CO₂, 15% by | | | | able |
| volume of N₂ + | | | | |
| 100 ppm of CO, + | | | | |
| 3% by volume of air | | | | |
| bleed | | | | |
| 60% by volume of H₂, | 432 mV | 402 mV | 525 mV | not |
| 25% by volume of | | | | measur- |
| CO₂, 15% by volume | | | | able |
| of N₂ + 100 ppm of | | | | |
| CO, + 1% by | | | | |
| volume of air bleed | | | | |

1. Catalyst-containing gas difflusion layer for a fuel cell, which comprises a porous support material and catalyst particles which are distributed uniformly over the entire volume of the gas diffusion layer.

2. Catalyst-containing gas diffusion layer according to claim 1, wherein the catalyst particles are immobilized on the surface of the porous support material.

3. Catalyst-containing gas difflusion layer according to claim 1, 2, wherein the catalyst particles have a mean particle size of from 1 to 100 nm.

4. Catalyst-containing gas diffusion layer according to claim 1, wherein the catalyst particles comprise a noble metal selected from the group consisting of Pt, Pd, Ru, Rh, Au, Ag, Ir, and Os, or an oxide thereof, or a mixture thereof, or an alloy thereof with a base metal.

5. Catalyst-containing gas diff-usion layer according to claim 1, wherein the catalyst particles are present on the gas difflusion layer in a concentration per unit area of from 0.01 to 100 mg of metal/cm².

6. Catalyst-containing gas diffusion layer according to claim 1, wherein the porous support material comprises woven carbon fibre fabric, carbon fibre nonwoven, carbon paper, carbon fibre mesh, synthetic fibre mesh coated with conductive material, woven polymer fibre fabric coated with conductive material, glass fibres coated with conductive material, foam coated with conductive material or woven metal fibre fabric or metal wire mesh.

7. Catalyst-coated gas diffusion layer according to claim 1, wherein the catalyst particles are gas-phase-active and are suitable for the oxidation of carbon monoxide.

8. Catalyst-containing gas diffusion layer according to claim 1, wherein the catalyst particles are gas-phase-active and are suitable for the conversion of carbon monoxide into methane.

9. Catalyst-containing gas diffusion layer according to claim 1, wherein the catalyst particles are suitable for the oxidation of methanol.

10. Process for producing a catalyst-containing gas diffusion layer according to claim 1, wherein the catalyst particles are formed on the porous support material by thermal decomposition of at least one precursor compound.

11. Process for producing a catalyst-containing gas diffusion layer according to claim 10, wherein the porous support material is treated with at least one precursor compound, is dried and is heat treated, with decomposition of the precursor compound occurring and the catalyst particles being formed and immobilized on the surface of the support material.

12. Process for producing a catalyst-containing gas diffusion layer according to claim 10, wherein a thermally decomposable metal compounds is used as a precursor compounds.

13. Process for producing a catalyst-containing gas diffusion layer according to claim 10, wherein one or more metal compounds selected from the group consisting of nitrates, carbonates, carboxylates, hydroxycarboxylates, acetates, lactates, butanoates, oxalates, formates, resinates and ethylhexanoates are used as precursor compound.

14. Process for producing a catalyst-containing gas diffusion layer according to claim 10, wherein the thermal decomposition comprises heat treatment which is carried out at a temperature of from 200 to 900° C.

15. Process for producing a catalyst-containing gas diffusion layer according to claim 10, wherein the thermal decomposition comprises heat treatment which is carried out under a gaseous atmosphere, preferably under air, nitrogen, hydrogen or mixtures thereof.

16. Process for producing a catalyst-containing gas diffusion layer according to claim 10, wherein the production is carried out in a continuous process.

17. A fuel cell for the removal of carbon monoxide from hydrogen-containing fuel gases comprising the catalyst-containing gas diffusion layer of claim 1.

18. A direct methanol fuel cell for oxidation of methanol comprising the catalyst-containing gas diffusion layer of claim 1.

19. Membrane-electrode unit for a low-temperature fuel cell, which comprises a catalyst-containing gas diffusion layer according to claim 1.
